(19) United States
(12) Patent Application Publication
(10) Pub. No.: US 2024/0248460 A1
(43) Pub. Date: Jul. 25, 2024

(54) TIMING SYNCHRONIZATION MECHANISM

(71) Applicant: NOKIA SOLUTIONS AND NETWORKS OY, Espoo (FI)

(72) Inventor: Yongkang WU, Hangzhou, Zhejiang (CN)

(21) Appl. No.: 18/557,994

(22) PCT Filed: May 31, 2021
(86) PCT No.: PCT/CN2021/097370

§ 371 Date: Oct. 30, 2023

(51) Int. Cl. G05B 19/418; H04W 24/04; H04W 24/10

(52) U.S. Cl. CPC G05B 19/4184; H04W 24/04; H04W 24/10; G05B 2219/31356

(57) ABSTRACT

Example embodiments of the present disclosure relate to devices, methods, apparatuses and computer readable storage media of timing synchronization and anomaly detection mechanism. The method comprises: receiving, from a first device, measurement data of an object with data identification information, the first device served by the network device: determining timing information about the measurement data, the timing information indicating a transmission time of the measurement data from the first device: and transmitting the measurement data with the data identification information and the timing information to a wireless controller of the network device for anomaly detection analysis on the object. Using the timing information from the base station as a stable reference time helps to achieve timing synchronization among multiple IoT sensors or field devices. Further, by means of intelligent edge computing, anomaly events occurred or to be occurred at the field devices can be detected in a timely manner.

### FIELD

Embodiments of the present disclosure generally relate to the field of telecommunication and in particular, to devices, methods, apparatus and computer readable storage media of a timing synchronization mechanism.

### BACKGROUND

The manufacturing industry is roughly divided into two categories: a process manufacturing and a discrete manufacturing, which depends on whether the production process can be interrupted. In some cases, these two categories of production processes are coexistence. For example, in production of radio frequency cables on a production line, the production process mainly involves three continuous production processes, namely wrapping foam layer, wrapping copper sheet and rolling thread, and wrapping sheath. Between these continuous production processes, there are discrete processing steps, and no fully integrated production machine is used in the process manufacturing industry.

When the production line is stared, the core material, such as, the copper tube, passes through the entire production line at a constant speed v, and various parameters on the cables are measured. It is necessary to adjust the parameters for trial operation until the process output parameters are stable. In the course of operation, once any of these parameters are significantly deviated from a normal value, the production line needs to be suspended for maintenance, and relevant materials will be scrapped. Thus, it is expected for the manufacturing system to detect anomaly, deviation or a failure event timely and implement timing synchronization among different production processes and processing steps.

### SUMMARY

In general, example embodiments of the present disclosure provide a solution of an enhanced timing synchronization and anomaly detection mechanism.

In a first aspect, there is provided a network device. The network device comprises at least one processor; and at least one memory including computer program codes; the at least one memory and the computer program codes are configured to, with the at least one processor, cause the network device at least to: receive, from a first device served by the network device, measurement data of an object with data identification information; determine timing information about the measurement data, the timing information indicating a transmission time of the measurement data from the first device; and transmit the measurement data with the data identification information and the timing information to a wireless controller of the network device for anomaly detection analysis on the object.

In a second aspect, there is provided a wireless controller. The wireless controller comprises at least one processor; and at least one memory including computer program codes; the at least one memory and the computer program codes are configured to, with the at least one processor, cause the wireless controller at least to: receive, from a network device serving a first device, measurement data of an object with data identification information and timing information about the measurement data, the measurement data measured by the first device, and the timing information determined at the network device and indicating a transmission time of the measurement data from the first device; determine whether the measurement data is valid; and in accordance with a determination that the measurement data is valid, cause an anomaly detection analysis on the objected to be performed based on the measurement data, the data identification information and the timing information.

In a third aspect, there is provided a first device. The first device comprises at least one processor; and at least one memory including computer program codes; the at least one memory and the computer program codes are configured to, with the at least one processor, cause the first device at least to: perform a measurement on an object; and transmit, to a network device serving the first device, measurement data of the object with data identification information, the data identification information comprising a data signature and a data sequence identifier format of the measurement data.

In a fourth aspect, there is provided a method. The method comprises: receiving, at a network device and from a first device, measurement data of an object with data identification information, the first device served by the network device; determining timing information about the measurement data, the timing information indicating a transmission time of the measurement data from the first device; and transmitting the measurement data with the data identification information and the timing information to a wireless controller of the network device for anomaly detection analysis on the object.

In a fifth aspect, there is provided a method. The method comprises: receiving, at a wireless controller and from a network device serving a first device, measurement data of an object with data identification information and timing information about the measurement data, the measurement data measured by the first device, and the timing information determined at the network device and indicating a transmission time of the measurement data from the first device; determining whether the measurement data is valid; and in accordance with a determination that the measurement data is valid, causing an anomaly detection analysis on the objected to be performed based on the measurement data, the data identification information and the timing information.

In a sixth aspect, there is provided a method. A method comprises: performing, at a first device, a measurement on an object; and transmitting, to a network device serving the first device, measurement data of the object with data identification information, the data identification information comprising a data signature and a data sequence identifier format of the measurement data.

In a seventh aspect, there is provided a first apparatus. The first apparatus comprises: means for receiving, from a first device, measurement data of an object with data identification information, the first device served by the first apparatus; means for determining timing information about the measurement data, the timing information indicating a transmission time of the measurement data from the first device; and means for transmitting the measurement data with the data identification information and the timing information to a wireless controller of the network device for anomaly detection analysis on the object.

In an eighth aspect, there is provided a second apparatus. The second apparatus comprises: means for receiving, from a network device serving a first device, measurement data of an object with data identification information and timing information about the measurement data, the measurement data measured by the first device, and the timing information determined at the network device and indicating a transmission time of the measurement data from the first device; means for determining whether the measurement data is valid; and means for in accordance with a determination that the measurement data is valid, causing an anomaly detection analysis on the objected to be performed based on the measurement data, the data identification information and the timing information.

In a ninth aspect, there is provided a third apparatus. The third apparatus comprises: means for performing a measurement on an object; and means for transmitting, to a network device serving the third apparatus, measurement data of the object with data identification information, the data identification information comprising a data signature and a data sequence identifier format of the measurement data.

In a tenth aspect, there is provided a computer readable medium having a computer program stored thereon which, when executed by at least one processor of a device, causes the device to carry out the method according to the fourth aspect.

In an eleventh aspect, there is provided a computer readable medium having a computer program stored thereon which, when executed by at least one processor of a device, causes the device to carry out the method according to the fifth aspect.

In a twelfth aspect, there is provided a computer readable medium having a computer program stored thereon which, when executed by at least one processor of a device, causes the device to carry out the method according to the sixth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example network system in which example embodiments of the present disclosure can be implemented;

FIG. 2 shows a signaling chart illustrating a process of timing synchronization and anomaly detection mechanism according to some example embodiments of the present disclosure;

FIG. 3 illustrates a schematic diagram of an example network device according to some example embodiments of the present disclosure;

FIG. 4 illustrates a schematic diagram of an example open RAN (O-RAN) architecture according to some example embodiments of the present disclosure;

FIG. 5 illustrates a flowchart of an example method of timing synchronization and anomaly detection mechanism according to some example embodiments of the present disclosure;

FIG. 6 illustrates a flowchart of an example method of timing synchronization and anomaly detection mechanism according to some example embodiments of the present disclosure;

FIG. 7 illustrates a flowchart of an example method of measurement reporting mechanism according to some example embodiments of the present disclosure

FIG. 8 shows a simplified block diagram of a device that is suitable for implementing example embodiments of the present disclosure; and

FIG. 9 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

Continue to take the production line for radio frequency cables as an example, the production line is assumed to have a typical moving speed of 0.4 m/s, and separate processes will act on a same cable position at different time instants. Each of the processes perform a local real time measurement and detect parameters. Once any of these parameters is detected to be significantly deviated from the normal value, the device for a corresponding process may then issue an alarm.

The position accuracy is assumed to be 1 mm in order to detect a correlated failure of the cable. This result in a requirement of 2.5 ms in timing accuracy of relevant data. Further, data quality is also important, and thus invalid data, orphan data (namely, no other data detected at the same time instant) and data with no accurate timestamp shall be discarded before performing any anomaly detection analysis on the cable.

This kind of separated detections has a drawback that only obvious errors can be detected. Further, typical Internet of Things (e.g., IoT) devices and gateway (with UE of a radio system) usually have no accurate timing source. The measurement data is reported in the order of magnitude of Is without synchronization.

In order to improve the manufacturing industry, the radio system may be introduced to attach accurate timestamp to the measurement data that is sent as uplink data transmission. However, a typical radio system, for example, the 4G system or the 5G system, has a big variation in network latency. For example, the 5G dedicated network has a measured average latency of 10 ms and an upper limit of 50 ms, and the upper limit may reach up to 250 ms. The radio system may incur data loss or other availability issue in runtime, and thus it is impossible to provide accurate timestamp and implement timing synchronization via typical radio system.

In order to solve the above and other potential problems, embodiments of the present disclosure provide an enhanced measurement reporting mechanism. Instead of controlling the latency variation in the uplink data transmission, the enhanced measurement reporting mechanism uses the receipt time at the base station of radio system (e.g., eNodeB, gNodeB, etc.) as a stable time reference, and focuses on identifying a stable relative time (e.g., slot or even mini-slot for 5G system) that uplink data received at gNB side while considering possible retransmission of the uplink data. Moreover, the measurement reporting mechanism also reports regularly the data sequence identifier and associated accurate timestamp to a wireless controller that may perform anomaly detection analysis and control the production line in a near real time manner.

Example embodiments of the present disclosure will be described in detail below with reference to the accompanying drawings. Principle and embodiments of the present disclosure will be described in detail below with reference to the accompanying drawings.

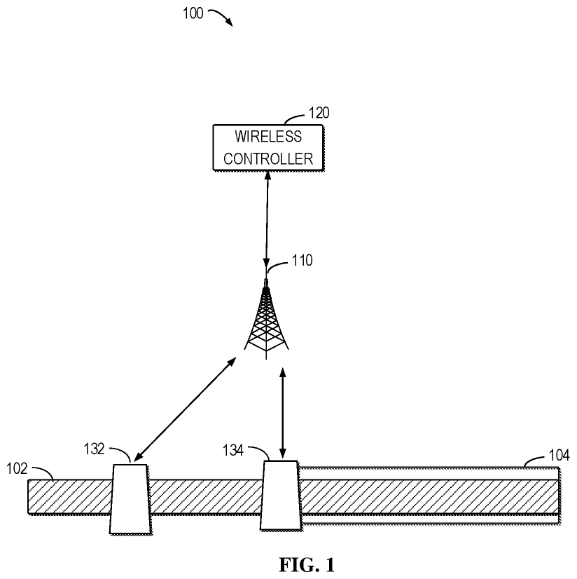

FIG. 1 shows an example network system 100 in which embodiments of the present disclosure can be implemented. As shown in FIG. 1, the network system 100 includes a network device 110, a wireless controller 120, a group of devices including first devices 132 and 134 and a core network 140.

The network system 100 may be a manufacturing system, for example, for production of radio frequency cables. The first devices 132 and 134 are deployed in the same production line and implement various production processes respectively. As shown in FIG. 1, the object 102 (e.g., a cable) moves at a constant speed on the production line and passes through the first devices 132 and 134.

When passing through the first device 132, the cable 102 is wrapped with a foam layer, and then when passing through the first device 134, the cable 102 is wrapped with a copper sheet 104. In course of operation, the first devices 132 and 134 perform measurements on the object 102, and obtain measurement data. The measurement data may be transmitted to the wireless controller via the network device 110 for anomaly detection analysis on production of the object 102.

For the measurement data measured by the first devices 132 and 134 for a specific position of the object 102, there is predetermined time gap that is based on the moving speed of the object 102. Due to a limited processing capability, production errors, absence of a synchronization timing source, the measurement data may be associated with inaccurate time measured by the first devices 132 and 134. If the anomaly detection analysis in turn impacts an accuracy of the anomaly detection analysis on production of the object 102.

The network device 110 provides a radio coverage and serves the group of devices 132 and 134. For example, the network device 110 may configure a network slice for the group of devices 132 and 134 with specific network resources and service level agreement (e.g., SLA). In an example of a 5G NR system, a specific RAN slice may be configured with the SLA assurance of a very stringent end to end latency requirement, for example, average 10 ms and a deviation of ±1.25 ms. As such, the group of devices may be identified by the slice identifier or a group identifier. Further, relevant terminal devices in a gateway or programmable logic controller (not shown) may be configured accordingly.

The network device 110 may also configure the group of devices with data identification information, including but not limited to, an uplink data signature, a data sequence identifier format of the measurement data, and so on. Alternatively, the data identification information may be predefined at the network device 110 and the first devices 132 and 134. The uplink data signature and the data sequence identifier format may be used as configurable identifiers for the network device 110 to identify the measurement data from all the uplink data, which will be discussed in details below.

Upon receipt measurement data with the data identification information from the first devices 132 and 134, the network device 110 may determine timing information about the measurement data. For example, the network device 110 may use the system time as a timestamp that indicates a relatively accurate transmission time of the measurement data from the first device 132 or 134.

In some example embodiments, the network device 110 may detect data loss or data error in the measurement data. Additionally or alternatively, the network device 110 may detect that there is a failure occurs, such as, uplink data transmission failure, buffer overflow, and the like. In these cases, the network device 110 may further transmit timing information about the data loss, data error or the failure.

The network device 110 may consider possible retransmissions of the measurement data, and the measurement data is assembled after several times Hybrid Automatic Repeat request (e.g., HARQ) retransmission. In this case, the network device 110 may determine and report the retransmission times at the same time.

The network device 110 is connected to the wireless controller 120 via, e.g., E2 interface. In some example embodiments, the wireless controller 120 may be a radio intelligence controller (RIC) that is further connected to a centralized control device for anomaly detection analysis via an open application programming interface (API). In some other example embodiments, the wireless controller 120 may further include the centralized control device having an edge computing capability, such as, the Multi-Access Edge Computing (MEC) device.

The wireless controller 120 receives the measurement data with the data identification information and the timing information from the network device 110. The wireless controller 120 may map the measurement data to a corresponding data structure as defined in E2 interface which is agreed with the network device 110.

By way of example, in a case where the measurement data is not ciphered on the user plane, the data signature and the data sequence identifier format are directly passed to the network device 110. In this case, the wireless controller 120 may determine that the timing information indicates a time instant for extracting the data sequence identifier format.

By way of another example, in a case where the measurement data is ciphered on the user plane, prior to extracting the data sequence identifier format, the measurement data will be deciphered at a packet data convergence protocol (e.g., PDCP) layer of the network device 110. In this case, the wireless controller 120 determines that there may be a time deviation due to the deciphering, and may apply a certain algorithm to improve the time accuracy.

The wireless controller 120 may determine whether the measurement data is valid. For example, in case of the data loss, data error, or the failure occurred at the network device 110, the measurement data may be considered as invalid data. For another example, if the measurement data is orphan data, that is, there is no other measurement data collected at the same time instant, or the measurement data is associated with inaccurate timestamp, the wireless controller 120 may determine that the measurement data is invalid. The invalid data may be ignored or discarded before performing the anomaly detection analysis on the object 102. In some example embodiments, the wireless controller 120 may apply pre-defined or pre-trained model to determine accurate timestamps of certain data sequence, and determine if certain data sequence is valid or not based on the data loss timestamp.

The wireless controller 120 may cause the anomaly detection analysis to be performed based on the measurement data, the data identification information and the timing information. In some example embodiments, the anomaly detection analysis may be performed by using intelligent edge computing functions, anomaly detection algorithms and the like. The wireless controller 120 may then obtain a result of the anomaly detection analysis that indicates an anomaly of the object 102.

In some example embodiments, the wireless controller 120 may transmit alarm information to the first device 132 or 134 based on the result of the anomaly detection analysis. As a result, the first device 132 or 134 may adjust its operations accordingly. Alternatively, the wireless controller 120 may transmit an alarm about the anomaly via LED light, warning tone, etc. to the end user of first device 132 or 134, or the operator of the production line to ask for human intervention.

It is to be understood that the number of first device and network device are only for the purpose of illustration without suggesting any limitations. The network system 100 may include any suitable number of first devices adapted for implementing embodiments of the present disclosure.

Only for case of discussion, the first devices 132 and 134 are illustrated as field devices in a production line, and the network device 110 is illustrated as a base station. It is to be understood that the field devices and the base station are only example implementations of the first devices 132 and 134 and the network device 110 respectively, without suggesting any limitation as to the scope of the present application. Any other suitable implementations are possible as well.

Depending on the communication technologies, the network system 100 may be a Code Division Multiple Access (CDMA) network, a Time Division Multiple Address (TDMA) network, a Frequency Division Multiple Access (FDMA) network, an Orthogonal Frequency-Division Multiple Access (OFDMA) network, a Single Carrier-Frequency Division Multiple Access (SC-FDMA) network or any others. Communications discussed in the network 100 may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies. For clarity, certain aspects of the techniques are described below for LTE, and LTE terminology is used in much of the description below.

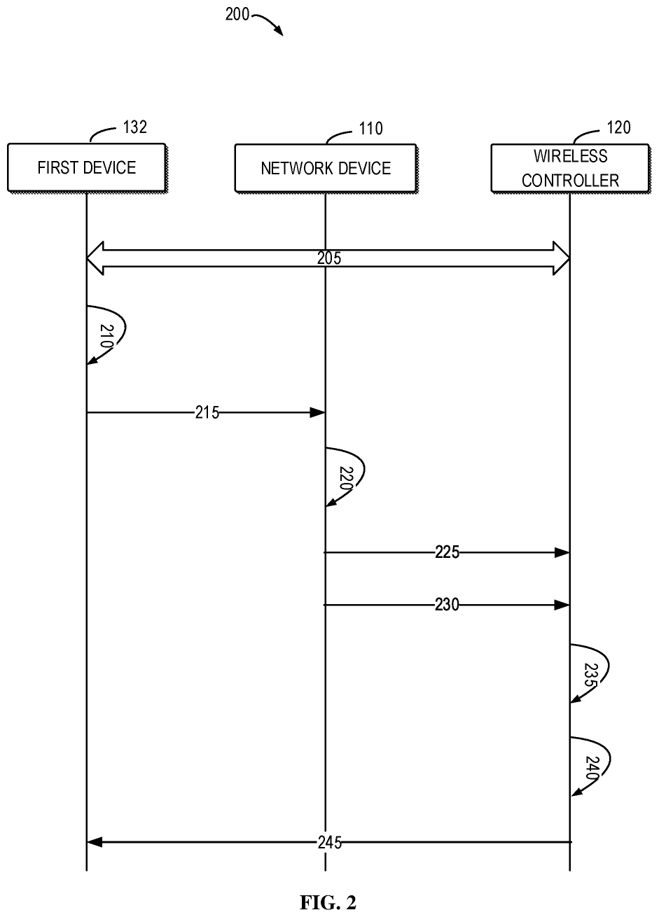

Principle and implementations of the present disclosure will be described in detail below with reference to FIG. 2. FIG. 2 shows a signaling chart illustrating a process 200 of timing synchronization and anomaly detection mechanism according to some example embodiments of the present disclosure. For the purpose of discussion, the process 200 will be described with reference to FIG. 1. The process 200 may involve the first devices 132 and 134, the network device 110 and the wireless controller 120 as shown in FIG. 1.

In the process 200, the network device 110 may establish 205 a network slice for a group of devices including the first devices 132 and 134. The network slice may be identified by a slice identifier or a group identifier of the group including the first devices 132 and 134.

In some example embodiments, the network device 110 may configure the group of devices with data identification information. Alternatively, the data identification information may be predefined at the first devices 132 and 134 and the network device 110. With the data identification information, the network device 110 may identify the measurement data from other uplink data transmissions. For example, for a dedicated network slice NSSAI-1, a signature string may be defined to be “TickMe@”, and data sequence id may be defined to be a 16 bits word in big endian. Application subscribes to the wireless controller 120 with the specific API with such information, and further to the network device 110, and applies to the connections related to the first devices 132 and 134.

The first device 132 performs 210 measurements on the object 102, and obtains measurement data with the data identification information. Similarly, the first device 134 performs measurements on the object 102, and obtains further measurement data with the data identification information.

The first device 132 transmits 215 the measurement data to the network device 110, for example, as uplink data transmissions. Similarly, the first device 134 may also transmit the further measurement data to the network device 110.

Upon receipt of the measurement data, the network device 110 determines 220 timing information about the measurement data. The timing information may indicate a transmission time of the measurement data from the first device 132. For example, the timing information may include first timing information for receipt of the measurement data at the network device 110. The network device 110 may use the system time or slot information as a timestamp of the measurement data.

Additionally or alternatively, the network device 110 may detect if there is data loss or data error in the measurement data, or if a failure occurs at the network device 110. In this case, the timing information may include second timing information about at least one of the data loss or the data error in the measurement data or the failure occurred at the network device 110.

Additionally or alternatively, the network device 110 may consider the retransmission of the measurement data. If the measurement data is assembled after several H-ARQ retransmissions, the timing information may include third timing information that indicates a retransmission time of the measurement data.

Similarly, the network device 110 may determine fourth timing information about the further measurement data. The fourth timing information may indicate a transmission time of the further measurement data from the first device 134.

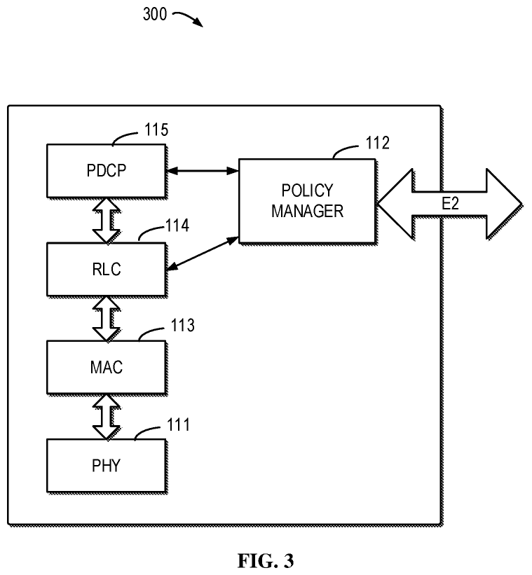

FIG. 3 illustrates a schematic diagram of an example network device 110 according to some example embodiments of the present disclosure. As shown in FIG. 3, the network device 110 may include a physical (PHY) layer 111, a policy manager 112, a media access control (MAC) layer 113, a radio link control (RLC) layer 114, a PDCP layer 115.

For example, the PHY layer 111 may report buffer overflow in uplink with timestamp. The RLC layer 114 may receive command from policy manager 112 for signature matching, data sequence identifier format extraction, and timestamp reporting. The PDCP layer 115 may receive command from the policy manager 112 for signature matching in uplink after deciphering, data sequence identifier format extraction and timestamp reporting, data loss event reporting, failure reporting and so on.

Specifically, upon receipt of the measurement data, the data signature of the measurement data may be detected at the RLC layer 114. The network device 110 may determine if the data signature matches the data signature configured by the network device 110. In a case that there is a match for the data signature and the measurement data is not ciphered on the user plane, the data sequence identifier format after the data signature may be extracted at the RLC layer 114. Once detection of the data sequence identifier format, the network device 110 may determine the current system time as the timing information for the measurement data, and deliver the measurement data with timing information to the policy manager device 112.

In a case that there is a match for the data signature and the measurement data is ciphered on the user plane, prior to extracting the data sequence identifier format, the measurement data may be deciphered at the PDCP layer 115. In this case, the policy manager device 112 may instruct the RLC layer 114 to store timestamp or slot information for each packet data unit (PDU), and the measurement data with send with the timestamp may be then delivered to the policy manager device 112. This may be also applicable to a PDCP ciphering disabled case, with the cost that the RLC layer 114 always stores timestamps for the first devices 132 and 134.

In a case where the buffer overflows, or a link failure happened, all of the components of the network device 110 shall report the event to the policy manager device 112 with the current system time. The policy manager device 112 may check if the event is related to the group of devices based on the connection topology of the network device 110.

The network device 110 transmits 225 the measurement data with the data identification information and the timing information to the wireless controller 120 for anomaly detection analysis on the object 102. In some example embodiments, the network device 110 may transmit 230 the data identification information and fourth timing information to the wireless controller 120 for anomaly detection analysis on the object 102.

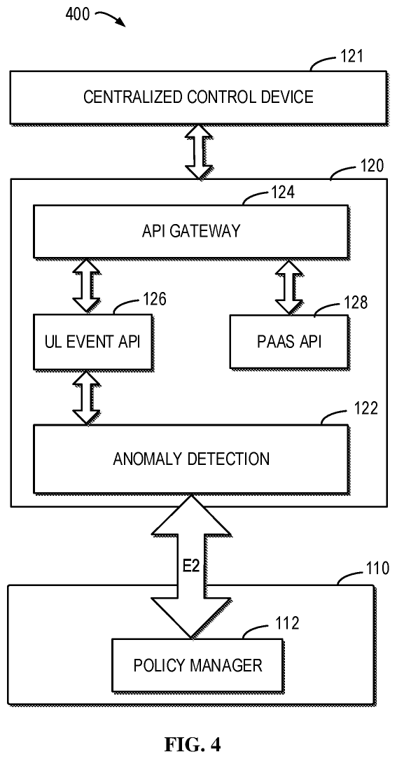

Upon receipt of the measurement data, the wireless device 120 determines 235 whether the measurement data is valid. Reference is made to FIG. 4, which illustrates a schematic diagram of an example open RAN (O-RAN) architecture 400 according to some example embodiments of the present disclosure. The O-RAN architecture 400 is given as one of various implementations of the network system 100 as shown in FIG. 1.

As shown in FIG. 4, the network device 110 is connected to the wireless controller 120 via E2 interface, and the wireless controller 120 is connected to a centralized control device 121 via open API. It should be understood that in other implementations of the network systems 100, the centralized control device 121 may not be implemented as a standalone device, and may be implemented as one of components of the wireless controller 120. The wireless controller 120 may include an anomaly detection device 122, an API gateway 124, an uplink event API 126 and a platform as a service (e.g., PAAS) API 128.

For example, if the data loss, data error, or the failure at the network device 110 is detected, the anomaly detection device 122 may determine that the measurement data is invalid.

For another example, if the measurement data is orphan data, that is, there is no other measurement data collected at the same time instant, or the measurement data is associated with inaccurate timestamp, the anomaly detection device 122 may determine that the measurement data is invalid. The anomaly detection device 122 may ignore or discard the invalid measurement data.

In some example embodiments, the anomaly detection device 122 may apply pre-defined or pre-trained model to determine accurate timestamps of certain data sequence, and determine if certain data sequence is valid or not based on the data loss timestamp. The anomaly detection device 122 may correlate the measurement data with the timing information based on the data identification information.

In a case where the wireless controller 120 is also provided with the further measurement data and the fourth timing information from the first device 134, the wireless controller 120 may determine if the further measurement data is valid. If the further measurement data is valid, the wireless controller 120 may correlate the measurement data, the timing information about the measurement data with the further measurement data and the fourth timing information based on a predetermined time gap. The predetermined time gap may depend on the moving speed of the object 102 on the production line. In this way, the wireless controller 120 may correlate the measurement data about a same position on the object 102.

The wireless device 120 then causes 240 the anomaly detection analysis on the objected to be performed based on the measurement data, the data identification information and the timing information. In some example embodiments, the anomaly detection analysis may be performed by the wireless controller 120.

In some other example embodiments, the anomaly detection analysis may be performed by the centralized control device 121 for performing the anomaly detection analysis. In these embodiments, the wireless controller 120 may transmit the measurement data with the data identification information and the timing information and optionally the further measurement data and the fourth timing information to the centralized control device 121 via open API. For example, the centralized control device 121 may receive the timestamp with the data sequence identifier or potential data loss event from the wireless controller 120 as “0001 at 2021-05-14T18:33:06, 784836882+08:00” or “Loss at 2021-05-14T18:33:06, 784836882+08:00” in a RESTful message. The centralized control device 121 may store the timestamp with the measurement data, additionally or alternatively drop the measurement data, and perform anomaly detection analysis, which may further be based on parameters taken from the production pipeline.

The wireless device 120 may obtain a result of the anomaly detection analysis. In a case where the result indicates an anomaly of the object 102, the wireless device 120 may then transmit alarm information about the anomaly. For example, the result of the anomaly detection analysis may indicate that an anomaly is occurred or to be occurred on the object 102. The alarm information may indicate, for example, an anomaly position on the object 102 or a measurement time of the first device 132.

In some example embodiments, the result of the anomaly detection analysis may be transmitted 245 to the group of devices. Upon receipt of the anomaly detection analysis, the first devices 132 and 134 may adjust their operations based on the result.

In some other example embodiments, upon receipt of the anomaly detection analysis, the first devices 132 and 134 may issue corresponding alarm signal indicating the anomaly to the end user or the operator of the production line to ask for human intervention. The alarm signal may take various forms, such as, LED light, warning tone, etc.

It should be understood that the example of production line is given as one of the implementations of the embodiments of the present disclosure, which can also be applied to other use cases of IoT sensors or detectors that needs time synchronization. Therefore, the scope of the present disclosure is not limited in this regard.

According to the example embodiments of the present disclosure, a mechanism for measurement reporting and anomaly detection. Using timing information provided by the base station as a stable reference time helps to achieve timing synchronization among multiple IoT sensors or field devices. Further, by means of intelligent edge computing functions, anomaly events occurred or to be occurred at the IoT sensors or field devices are detected in a timely manner. As such, a production cost can be reduced, and system efficiency and reliability can be improved.

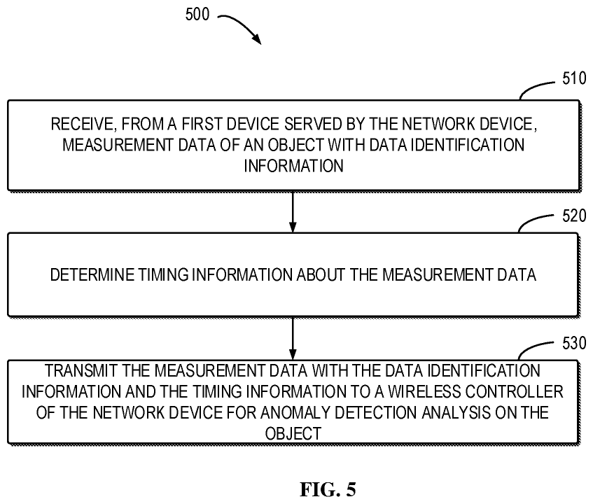

FIG. 5 illustrates a flowchart of an example method 500 for timing synchronization and anomaly detection according to some example embodiments of the present disclosure. The method 500 can be implemented at a base station, e.g., the network device 110 described with reference to FIG. 1. For the purpose of discussion, the method 500 will be described with reference to FIG. 1.

At 510, the network device 110 receives, from a first device 132 served by the network device 110, measurement data of an object with data identification information. For example, the measurement data may be “TickMe@”_0001_<structure header>_<float 1>_<float_2>_<float_3> . . . .

At 520, the network device 110 determines timing information about the measurement data, the timing information indicating a transmission time of the measurement data from the first device. In some example embodiments, the data identification information may include a data signature and a data sequence identifier format of the measurement data.

In some example embodiments, the timing information may include at least one of first timing information for receipt of the measurement data at the network device 110, second timing information about at least one of a data loss or the data error in the measurement data or a failure occurred at the network device 110, or third timing information that indicates a retransmission time of the measurement data.

In some example embodiments, the network device 110 may detect at least one of the data loss or the data error occurred in the measurement data or the failure occurred at the network device 110.

In some example embodiments where the data signature is detected, the network device 110 may extract the data sequence identifier format from the measurement data at a radio link control, RLC, layer of the network device 110. The network device 110 may then determine the timing information for extracting the data sequence identifier format.

In the above embodiments, in a case where the measurement data is ciphered on a user plane corresponding to the first device 132, prior to extracting the data sequence identifier format, the network device 110 may decipher the measurement data at a packet data convergence protocol, PDCP, layer of the network device 110.

In some example embodiments where the first device 132 is one of a group of devices, the network device 110 may receive further measurement data of the object with the data identification information from at least one device in the group other than the first device 132, for example, the first device 134. The network device 110 may determine fourth timing information about the further measurement data. The fourth timing information may indicate a transmission time of the further measurement data from the at least one device. The network device 110 may transmit the data identification information and the fourth timing information to the wireless controller 120 for anomaly detection analysis on the object.

At 530, the network device 110 transmits the measurement data with the data identification information and the timing information to the wireless controller 120 of the network device 110 for anomaly detection analysis on the object.

According to the example embodiments of the present disclosure, a mechanism for measurement reporting and anomaly detection. Using timing information provided by the base station as a stable reference time helps to achieve timing synchronization among multiple IoT sensors or field devices. Further, by means of intelligent edge computing functions, anomaly events occurred or to be occurred at the IoT sensors or field devices are detected in a timely manner. As such, a production cost can be reduced, and system efficiency and reliability can be improved.

FIG. 6 illustrates a flowchart of an example method 600 for timing synchronization and anomaly detection according to some example embodiments of the present disclosure. The method 600 can be implemented at a wireless controller, e.g., the wireless controller 120 described with reference to FIG. 1. For the purpose of discussion, the method 600 will be described with reference to FIG. 1.

At 610, the wireless controller 120 receives, from a network device 110 serving a first device 132, measurement data of an object with data identification information and timing information about the measurement data. The measurement data is measured by the first device 132, and the timing information is determined at the network device 110 and indicates a transmission time of the measurement data from the first device 132.

In some example embodiments, the timing information comprises at least one of first timing information for receipt of the measurement data at the network device, second timing information about at least one of a data loss or the data error in the measurement data or a failure occurred at the network device, or third timing information indicating a retransmission time of the measurement data.

In some example embodiments, the data identification information may include a measurement data signature and a data sequence identifier format of the measurement data.

At 620, the wireless controller 120 determines whether the measurement data is valid.

In some example embodiments, the wireless controller 120 may correlate the measurement data with the timing information based on the data identification information. The wireless controller 120 may determine whether an anomaly occurred or to be occurred at the first device 132 based on the measurement data and the timing information.

In some example embodiments, the wireless controller 120 may receive further measurement data of the object with the data identification information and fourth timing information about the further measurement data. The further measurement data is measured by at least one device in the group other than the first device, for example, the first device 134. The fourth timing information is determined at a network device 110 serving the at least one device 134. The wireless controller 120 may determine if the further measurement is valid. If the further measurement is valid, the wireless controller 120 may correlate the measurement data, the timing information about the measurement data, with further measurement data and the fourth timing information based on a predetermined time gap. Otherwise, if the further measurement data is invalid, the wireless controller 120 may discard the further measurement data.

If the measurement data is valid, at 630, the wireless controller 120 causes an anomaly detection analysis on the objected to be performed based on the measurement data, the data identification information and the timing information.

In some example embodiments, the wireless controller 120 may obtain a result of the anomaly detection analysis indicating an anomaly of the object. In this case, the wireless controller 120 may transmit alarm information about the anomaly. The result of the anomaly detection analysis may indicate the anomaly occurred or to be occurred on the object. Additionally or alternatively, the alarm information may include at least one of an anomaly position on the object or a measurement time of the first device 132.

In some example embodiments, the anomaly detection analysis may be performed by the wireless controller 120.

In some example embodiments, the wireless controller 120 may transmit the measurement data with the data identification information and the timing information to a centralized control device 121 for performing the anomaly detection analysis.

In some example embodiments, the timing information may include first timing information that indicates a time for extracting the data sequence identifier format from the measurement data at a radio link control, RLC, layer of the network device 110.

In some example embodiments where the measurement data is ciphered on a user plane corresponding to the first device 132, the timing information may include first timing information that indicate a time for extracting the data sequence identifier format from the measurement data at the RLC layer of the network device 110 after the measurement data is deciphered at a packet data convergence protocol, PDCP, layer of the network device 110.

In comparison with a speed of the production line (e.g., 2.5 ms for 1 mm), the timestamp from field devices is typically not accurate enough to correlate two or more sets of data from multiple field devices. According to the example embodiments of the present disclosure, there is provided a mechanism for measurement reporting and anomaly detection. The enhanced mechanism uses the relatively accurate timestamps for the uplink events as a time reference, and thus, timing synchronization can be achieved among multiple fields devices. Further, inaccurate data, invalid data and orphan data are ignored or discarded in the mechanism, even if the RAN device reports false positive events, it may not affect the accuracy of anomaly detection analysis. As such, a production cost can be reduced, and system efficiency and reliability can be improved.

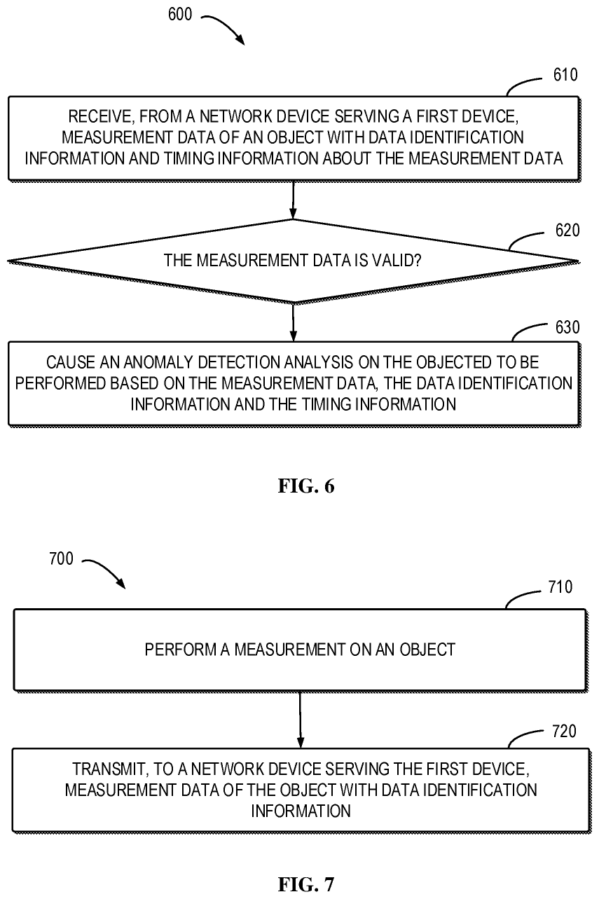

FIG. 7 illustrates a flowchart of an example method 700 for timing synchronization and anomaly detection according to some example embodiments of the present disclosure. The method 700 can be implemented at a field device or a terminal device, e.g., the first device 132 described with reference to FIG. 1. For the purpose of discussion, the method 700 will be described with reference to FIG. 1.

At 710, the first device 132 may perform a measurement on an object.

At 720, the first device 132 may transmit, to a network device 110 serving the first device 132, measurement data of the object with data identification information. The data identification information may include a data signature and a data sequence identifier format of the measurement data.

In some example embodiments, the data identification information may be configured by the network device 110 or predefined. For example, the first device 132 may transmit measurement data “TickMe@”_0001_<structure header>_<float 1>_<float_2>_<float_3> . . . to the network device 110.

In some example embodiments, the first device 132 may receive, from the network device 110, a result of an anomaly detection analysis on the object. The anomaly detection analysis may be performed based on the measurement data, and timing information about the measurement data may be determined by the network device 110.

The first device 132 may then adjust an operation of the first device 132 based on the result of the anomaly detection analysis.

In some example embodiments, the first device 132 may receive, from the network device 110, a result of an anomaly detection analysis on the object. The anomaly detection analysis may be performed based on the measurement data and timing information about the measurement data determined by the network device 110. The result of the anomaly detection analysis may indicate an anomaly occurred or to be occurred on the object. The first device 132 may then transmit an alarm signal that indicates the anomaly. For example, the alarm signal may indicate an anomaly position on the object.

According to the example embodiments of the present disclosure, a mechanism for measurement reporting and anomaly detection. Using timing information provided by the base station as a stable reference time helps to achieve timing synchronization among multiple IoT sensors or field devices. Together with the parameters taken from the production pipeline, the wireless controller can further apply anomaly detection algorithm to combine all the events and measurements of the same position of the final product to detect if any potential production failure occurs. As such, the operations of the field devices can be adjusted accordingly and a waste in production can be avoided.

In some example embodiments, a first apparatus capable of performing the method 500 (for example, the network device 110) may comprise means for performing the respective steps of the method 500. The means may be implemented in any suitable form. For example, the means may be implemented in a circuitry or software module. The first apparatus may be implemented as or included in the network device 110. In some embodiments, the means may comprise at least one processor and at least one memory including computer program code. The at least one memory and computer program code are configured to, with the at least one processor, cause performance of the first apparatus.

In some example embodiments, the first apparatus comprises: means for receiving, from a first device, measurement data of an object with data identification information, the first device served by the first apparatus; means for determining timing information about the measurement data, the timing information indicating a transmission time of the measurement data from the first device; and means for transmitting the measurement data with the data identification information and the timing information to a wireless controller of the first apparatus for anomaly detection analysis on the object.

In some example embodiments, the timing information comprises at least one of the following: first timing information for receipt of the measurement data at the first apparatus, second timing information about at least one of a data loss or the data error in the measurement data or a failure occurred at the first apparatus, or third timing information indicating a retransmission time of the measurement data.

In some example embodiments, the first apparatus further comprises means for detecting at least one of the data loss or the data error occurred in the measurement data or the failure occurred at the first apparatus.

In some example embodiments, the data identification information comprises a data signature and a data sequence identifier format of the measurement data.

In some example embodiments, the means for determining the timing information comprises: means for in accordance with detection of the data signature, extracting the data sequence identifier format from the measurement data at a radio link control, RLC, layer of the first apparatus; and means for determining the timing information for extracting the data sequence identifier format.

In some example embodiments, the measurement data is ciphered on a user plane corresponding to the first device, and the means for determining the timing information comprises: means for prior to extracting the data sequence identifier format, deciphering the measurement data at a packet data convergence protocol, PDCP, layer of the first apparatus.

In some example embodiments, the first device is one of a group of devices, and the first apparatus further comprises: means for receiving, from at least one device in the group other than the first device, further measurement data of the object with the data identification information; means for determining fourth timing information about the further measurement data, the fourth timing information indicating a transmission time of the further measurement data from the at least one device; and means for transmitting the data identification information and the fourth timing information to the wireless controller for anomaly detection analysis on the object.

In some example embodiments, the first apparatus is an access network device, and the first device is one of a field device or a terminal device.

In some example embodiments, a second apparatus capable of performing the method 600 (for example, the wireless controller 120) may comprise means for performing the respective steps of the method 600. The means may be implemented in any suitable form. For example, the means may be implemented in a circuitry or software module. The second apparatus may be implemented as or included in the wireless controller 120. In some embodiments, the means may comprise at least one processor and at least one memory including computer program code. The at least one memory and computer program code are configured to, with the at least one processor, cause performance of the second apparatus.

In some example embodiments, the second apparatus comprises: means for receiving, from a network device serving a first device, measurement data of an object with data identification information and timing information about the measurement data, the measurement data measured by the first device, and the timing information determined at the network device and indicating a transmission time of the measurement data from the first device; means for determining whether the measurement data is valid; and means for in accordance with a determination that the measurement data is valid, causing an anomaly detection analysis on the objected to be performed based on the measurement data, the data identification information and the timing information.

In some example embodiments, the timing information comprises at least one of the following: first timing information for receipt of the measurement data at the network device, second timing information about at least one of a data loss or the data error in the measurement data or a failure occurred at the network device, or third timing information indicating a retransmission time of the measurement data.

In some example embodiments, the means for causing the anomaly detection analysis to be performed comprises: means for correlating the measurement data with the timing information based on the data identification information; and means for determining whether an anomaly occurred or to be occurred at the first device based on the measurement data and the timing information.

In some example embodiments, the data identification information comprises a measurement data signature and a data sequence identifier format of the measurement data.

In some example embodiments, the first device is one of a group of devices, and the second apparatus further comprises: means for receiving further measurement data of the object with the data identification information and fourth timing information about the further measurement data, the further measurement data measured by at least one device in the group other than the first device, the fourth timing information determined at a network device serving the at least one device; and means for in accordance with a determination that the further measurement data is valid, correlating the measurement data, the timing information about the measurement data, with further measurement data and the fourth timing information based on a predetermined time gap.

In some example embodiments, the first device is one of a group of devices, and the second apparatus further comprises: means for in accordance with a determination that the further measurement data is invalid, discarding the further measurement data.

In some example embodiments, the second apparatus further comprises: means for in accordance with a determination that the measurement gap pattern comprises at least one measurement gap configuration for at least one further bandwidth part not requiring the measurement gap in the set, discarding the at least one measurement gap configuration for the at least one further bandwidth part.

In some example embodiments, the second apparatus further comprises: means for obtaining a result of the anomaly detection analysis indicating an anomaly of the object; and means for transmitting alarm information about the anomaly.

In some example embodiments, the result of the anomaly detection analysis indicates the anomaly occurred or to be occurred on the object, and the alarm information comprises at least one of an anomaly position on the object or a measurement time of the first device.

In some example embodiments, the anomaly detection analysis is performed by the second apparatus.

In some example embodiments, the means for causing the anomaly detection analysis to be performed comprises: means for transmitting the measurement data with the data identification information and the timing information to a centralized control device for performing the anomaly detection analysis.

In some example embodiments, the timing information comprises first timing information indicating a time for extracting the data sequence identifier format from the measurement data at a radio link control, RLC, layer of the network device.

In some example embodiments, the measurement data is ciphered on a user plane corresponding to the first device, and the timing information comprises first timing information indicating a time for extracting the data sequence identifier format from the measurement data at the RLC layer of the network device after the measurement data is deciphered at a packet data convergence protocol, PDCP, layer of the network device.

In some example embodiments, the network device is an access network device, and the first device is one of a field device or a terminal device.

In some example embodiments, a third apparatus capable of performing the method 700 (for example, the first device 132 or 134) may comprise means for performing the respective steps of the method 700. The means may be implemented in any suitable form. For example, the means may be implemented in a circuitry or software module. The third apparatus may be implemented as or included in the first device 132 or 134. In some embodiments, the means may comprise at least one processor and at least one memory including computer program code. The at least one memory and computer program code are configured to, with the at least one processor, cause performance of the third apparatus.

In some example embodiments, the third apparatus comprises: means for performing a measurement on an object; and means for transmitting, to a network device serving the third apparatus, measurement data of the object with data identification information, the data identification information comprising a data signature and a data sequence identifier format of the measurement data.

In some example embodiments, the data identification information is configured by the network device or predefined.

In some example embodiments, the third apparatus further comprises: means for receiving, from the network device, a result of an anomaly detection analysis on the object, the anomaly detection analysis performed based on the measurement data and timing information about the measurement data determined by the network device; and means for adjusting an operation of the first device based on the result of the anomaly detection analysis.

In some example embodiments, the third apparatus further comprises: means for receiving, from the network device, a result of an anomaly detection analysis on the object, the anomaly detection analysis performed based on the measurement data and timing information about the measurement data determined by the network device, the result of the anomaly detection analysis indicating an anomaly occurred or to be occurred on the object; and means for transmitting an alarm signal indicating the anomaly.

In some example embodiments, the alarm signal indicates an anomaly position on the object.

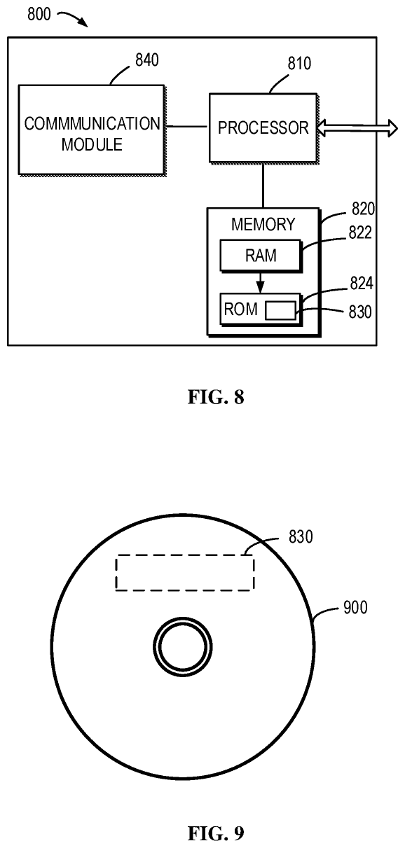

FIG. 8 is a simplified block diagram of a device 800 that is suitable for implementing embodiments of the present disclosure. The device 800 may be provided to implement the communication device, for example the network device 110, the wireless controller 120, and the first device 132 or 134 as shown in FIG. 1. As shown, the device 800 includes one or more processors 810, one or more memories 840 coupled to the processor 810, and one or more transmitters and/or receivers (TX/RX) 840 coupled to the processor 810.

The TX/RX 840 is for bidirectional communications. The TX/RX 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the ROM 820. The processor 810 may perform any suitable actions and processing by loading the program 830 into the RAM 820.

The embodiments of the present disclosure may be implemented by means of the program 830 so that the device 800 may perform any process of the disclosure as discussed with reference to FIGS. 5-7. The embodiments of the present disclosure may also be implemented by hardware or by a combination of software and hardware.

In some embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like. FIG. 9 shows an example of the computer readable medium 900 in form of CD or DVD. The computer readable medium has the program 830 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 500 to 700 as described above with reference to FIGS. 5 to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A network device comprising:
at least one processor; and
at least one memory including computer program code,
the at least one memory and the computer program code configured to, with the at least one processor, cause the network device to:
receive, from a first device served by the network device, measurement data of an object with data identification information;
determine timing information about the measurement data, the timing information indicating a transmission time of the measurement data from the first device; and
transmit the measurement data with the data identification information and the timing information to a wireless controller of the network device for anomaly detection analysis on the object.

2. The network device of claim 1, wherein the timing information comprises at least one of the following:
first timing information for receipt of the measurement data at the network device,
second timing information about at least one of a data loss or the data error in the measurement data or a failure occurred at the network device, or
third timing information indicating a retransmission time of the measurement data.

3. The network device of claim 2, wherein the at least one memory and the computer program code are configured to, with the at least one processor, further cause the network device to:
detect at least one of the data loss or the data error occurred in the measurement data or the failure occurred at the network device.

4. The network device of claim 1, wherein the data identification information comprises a data signature and a data sequence identifier format of the measurement data.

5. The network device of claim 4, wherein the at least one memory and the computer program code are configured to, with the at least one processor, cause the network device to determine the timing information by:
in accordance with detection of the data signature, extracting the data sequence identifier format from the measurement data at a radio link control, RLC, layer of the network device; and
determining the timing information for extracting the data sequence identifier format.

6. The network device of claim 5, wherein the measurement data is ciphered on a user plane corresponding to the first device and wherein the at least one memory and the computer program code configured to, with the at least one processor, further cause the network device to determine the timing information by:
prior to extracting the data sequence identifier format, deciphering the measurement data at a packet data convergence protocol, PDCP, layer of the network device.

7. The network device of claim 1, wherein the first device is one of a group of devices, and wherein the at least one memory and the computer program code are configured to, with the at least one processor, further cause the network device to:
receive, from at least one device in the group other than the first device, further measurement data of the object with the data identification information;
determine fourth timing information about the further measurement data, the fourth timing information indicating a transmission time of the further measurement data from the at least one device; and
transmit the data identification information and the fourth timing information to the wireless controller for anomaly detection analysis on the object.

8. The network device of claim 1, wherein the network device comprises an access network device, and the first device comprises one of a field device or a terminal device.

9. A wireless controller comprising:
at least one processor; and
at least one memory including computer program code,
the at least one memory and the computer program code configured to, with the at least one processor, cause the wireless controller to:
receive, from a network device serving a first device, measurement data of an object with data identification information and timing information about the measurement data, the measurement data measured by the first device, and the timing information determined at the network device and indicating a transmission time of the measurement data from the first device;
determine whether the measurement data is valid; and
in accordance with a determination that the measurement data is valid, cause an anomaly detection analysis on the objected to be performed based on the measurement data, the data identification information and the timing information.

10. The wireless controller of claim 9, wherein the timing information comprises at least one of the following:
first timing information for receipt of the measurement data at the network device,
second timing information about at least one of a data loss or the data error in the measurement data or a failure occurred at the network device, or
third timing information indicating a retransmission time of the measurement data.

11. The wireless controller of claim 9, wherein the at least one memory and the computer program code are configured to, with the at least one processor, cause the wireless controller to cause the anomaly detection analysis to be performed by:
correlating the measurement data with the timing information based on the data identification information; and
determining whether an anomaly occurred or to be occurred at the first device based on the measurement data and the timing information.

12. The wireless controller of claim 9, wherein the data identification information comprises a measurement data signature and a data sequence identifier format of the measurement data.

13. The wireless controller of claim 9, wherein the first device is one of a group of devices, and wherein the at least one memory and the computer program code are configured to, with the at least one processor, further cause the wireless controller to:
receive further measurement data of the object with the data identification information and fourth timing information about the further measurement data, the further measurement data measured by at least one device in the group other than the first device, the fourth timing information determined at a network device serving the at least one device; and
in accordance with a determination that the further measurement data is valid, correlate the measurement data, the timing information about the measurement data, with further measurement data and the fourth timing information based on a predetermined time gap.

14. The wireless controller of claim 13, wherein the first device is one of a group of devices, and wherein the at least one memory and the computer program code are configured to, with the at least one processor, further cause the wireless controller to:
in accordance with a determination that the further measurement data is invalid, discard the further measurement data.

15. The wireless controller of claim 9, wherein the at least one memory and the computer program code are configured to, with the at least one processor, further cause the wireless controller to:
obtain a result of the anomaly detection analysis indicating an anomaly of the object; and
transmit alarm information about the anomaly.

16. The wireless controller of €claim 15, wherein the result of the anomaly detection analysis indicates the anomaly occurred or to be occurred on the object, and the alarm information comprises at least one of an anomaly position on the object or a measurement time of the first device.

17. The wireless controller of claim 9, wherein the anomaly detection analysis is performed by the wireless controller.

18. The wireless controller of claim 9, wherein the at least one memory and the computer program code are configured to, with the at least one processor, cause the wireless controller to cause the anomaly detection analysis to be performed by:
transmitting the measurement data with the data identification information and the timing information to a centralized control device for performing the anomaly detection analysis.

19. The wireless controller of claim 9, wherein the timing information comprises first timing information indicating a time for extracting the data sequence identifier format from the measurement data at a radio link control, RLC, layer of the network device.

20. The wireless controller of claim 19, wherein the measurement data is ciphered on a user plane corresponding to the first device, and the timing information comprises first timing information indicating a time for extracting the data sequence identifier format from the measurement data at the RLC layer of the network device after the measurement data is deciphered at a packet data convergence protocol, PDCP, layer of the network device.

21.-33. (canceled)
